(19) United States
(12) Patent Application Publication
(10) Pub. No.: US 2011/0106857 A1
(43) Pub. Date: May 5, 2011

(54) Method for Automatically Adding an Address into an Address Book

(75) Inventors: Philippe Besombe, Louannec (FR); Loïc Pieto, Rospez (FR)

(73) Assignee: FRANCE TELECOM, Paris (FR)

(21) Appl. No.: 13/001,409

(22) PCT Filed: Jun. 17, 2009
(86) PCT No.: PCT/FR2009/051153

§ 371 Date: Dec. 23, 2010

(30) Foreign Application Priority Data
Jun. 24, 2008 (FR) 08 54168

(51) Int. Cl. G06F 17/30

(52) U.S. Cl. 707/803; 707/E17.005

(57) ABSTRACT

A method for automatic addition of an address of a correspondent to an address book of a user, a communications session having been established between said user and said correspondent, said method comprising a step for obtaining said address, and a step for adding said address to said address book, said addition step being conditioned by the adherence to at least one rule taking into account a communication history of said user, wherein said addition step is preceded by a step for determination of a common contact between said user and said correspondent.

The present invention relates generally to the field of telecommunications, and more precisely, to the automatic management of an address book of a user, this address book being either in a terminal of the user, such as a mobile telephone, a PDA (from the English term “Personal Digital Assistant”) or a desktop computer, or else hosted within the communications network of an operator to which the user subscribes.

The current techniques for managing address books are essentially manual techniques: the user of a terminal adds himself the contacts that seem relevant to him for being added to the address book of his terminal, sometimes at the suggestion of the terminal during a missed incoming call, originating from a correspondent whose number is not masked and which does not already appear in the address book of the terminal.

These existing techniques are not therefore very practical for the user: in most cases, he must himself input a telephone number and an associated contact name into his address book, each time the addition of a new contact to his address book seems appropriate to him.

The patent application JP2004153420A partially solves this problem by providing a system allowing an index of an address book of a user to be automatically prepared, based on a communication history. This history is collected by a server which, by carrying out statistics, for example on the contacts most called by the user, determines the contacts most appropriate to being added to the address book.

This system has the advantage of automatically determining the contacts to be added or not to the address book of the user, without the user having to himself input the telephone numbers of these contacts. However, the user finds himself with a list of telephone numbers in his address book, which is not very relevant: for example, if the user is regularly called by an advertisement service, or a weather service by text message (or SMS, from the English term “Short Message Service”), the system will automatically add the telephone numbers corresponding to these services to the address book of the user, which is in fact not desirable. In addition, with this system it is not straightforward for the user to remember to which contact a telephone number present in his address book corresponds. Indeed, since the presentation of the name corresponding to a telephone number is not usually the norm in communications networks, this system does not generally have the possibility of automatically associating a name with each telephone number that it automatically adds to the address book of the user.

The present invention provides a solution that does not exhibit the aforementioned drawbacks, by providing a method and a system for automatically adding an address of a correspondent to an address book of a user, which takes into account the preferences of the user.

For this purpose, the invention provides a method for automatically adding an address of a correspondent to an address book of a user, a communications session having been established between said user and said correspondent, said method comprising a step for obtaining said address, and a step for adding said address to said address book, said addition step being conditioned by the result of said determination step and the respect of at least one rule taking into account a communication history of said user, said method being characterized in that said addition step is preceded by a step for determining a common contact between said user and said correspondent.

It should be noted that, in this application, the address of the correspondent which is added to the address book of the user is to be understood as an address allowing the user to communicate with this correspondent. Hence, this is, for example, a telephone number, an SIP (from the English term “Session Initiation Protocol”) address, or perhaps an email address of the correspondent.

Thanks to the invention, the criterion for adding a contact to the address book of the user depends on:
the communications that the user has previously had with this contact, who is therefore his correspondent in said communications session previously established,
but also the common contacts between this contact and the user.

Thus, this addition criterion is more relevant than in the prior art, since the preferences of the user are taken into account. For example, a correspondent is automatically added to the address book of the user when he has called the user a predetermined number of times, and when he is in the address book of a contact of the user.

In addition, said determination step uses for example a database of a social network to which said user belongs. Various social networks are usable, such as Facebook® or Pikeo®, which allow it to be determined what are the social links between the user and the correspondent, and thus whether the addition of the correspondent to the address book of the user is relevant. It is therefore possible to define very precise addition criteria, for example that not only depend on a level of connectivity between the user and the correspondent in these social networks, but also depending on common fields of interest.

Alternatively, when an address book of the common contact or an address book of the correspondent are accessible from a communications network, and when an address of said common contact is present in the address book of the user, said determination step uses data contained in at least one of said address books of the common contact or of the correspondent, a common contact between the user and the correspondent being determined if an address of the correspondent is present in said address book of the common contact, or if said address of the common contact is present both in said address book of the user and said address book of the correspondent.

This alternative implementation is simpler than the use of social networks, but is applicable where the contacts of the user have an online address book, or in the case where the correspondent himself has an online address book. Furthermore, since access to these address books is generally protected, this alternative implementation may especially be envisioned in the case where the method for automatic addition according to the invention is implemented by the operator of the user. Indeed, the operator of the user has the necessary permissions for accessing the online address books of its subscribers, and, for the online address books of subscribers to other operators, it has the possibility of establishing agreements with the latter for at least obtaining information on connectivity between subscribers.

According to an advantageous feature, said determination step is followed by a step for obtaining additional information linked to said correspondent and contained in said social network or in said address book of said common contact.

This feature allows, for example, a nickname or a name associated with the address of the correspondent to be recovered, or perhaps a geographical address for example. It is thus possible to complete, in the address book of the user, the new entry corresponding to the correspondent whose address has previously been obtained by this additional information on the correspondent. This additional information allows the user to easily find his correspondent in his address book, because the address of the correspondent is not necessarily very explicit, notably if it consists of a telephone number. By the use of data associated with the correspondent and accessible by a communications network, this feature avoids the user having to search himself for this type of additional information then to input it manually into his address book.

According to another advantageous feature, said addition step is preceded by a step requesting confirmation from the user of the addition of said address to said address book of the user.

This other feature allows the user to decline the automatic addition of a contact when this addition does not appear relevant to him.

According to another advantageous feature, said step requesting confirmation is followed by a step for receiving information associated with said address, supplied by the user.

This feature allows the user to complete the new entry corresponding to the correspondent in the address book of the user, for example by adding the name of the correspondent to it. The request for confirmation, for example, suggests to the user to add information in order to complete this new entry, or presents him with information to be added, obtained through a social network or through the address book of the common contact. In this last case, the user only has to correct or complete this information presented to him.

The invention also relates to a system for automatically adding an address of a correspondent to an address book of a user, a communications session having been established between said user and said correspondent, said system comprising means for obtaining said address, and means for adding said address to said address book depending on a set of rules taking account of a communication history of said user, said system being characterized in that it also comprises means for determining a common contact between said user and said correspondent, said determination means being used by at least one of said rules.

The invention further relates to a computer program comprising instructions for implementing the method for automatic addition according to the invention, when it is executed on at least one processor.

The system for automatic addition according to the invention and the computer program according to the invention offer advantages analogous to those of the method for automatic addition according to the invention.

Other features and advantages will become apparent upon reading preferred embodiments described with reference to figures in which:

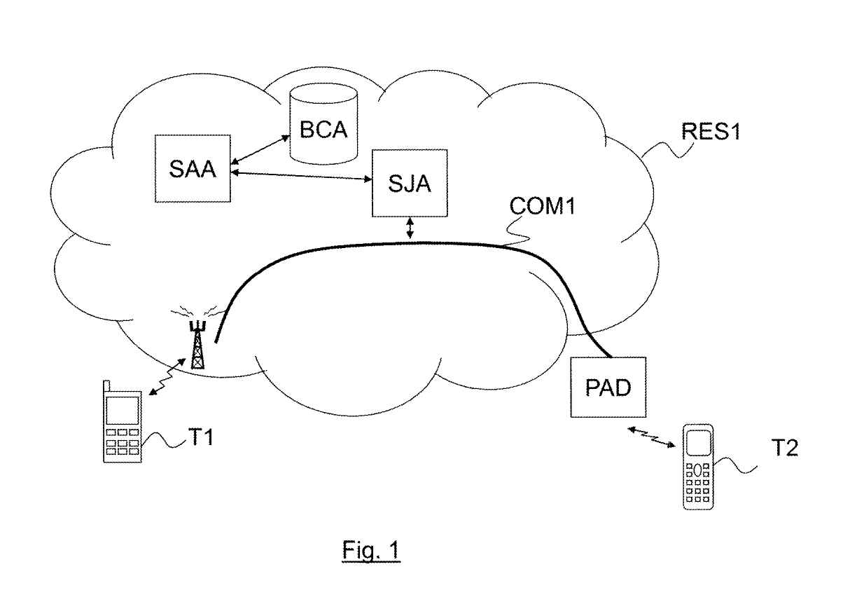

FIG. 1 shows a first embodiment of the system for automatic addition according to the invention,

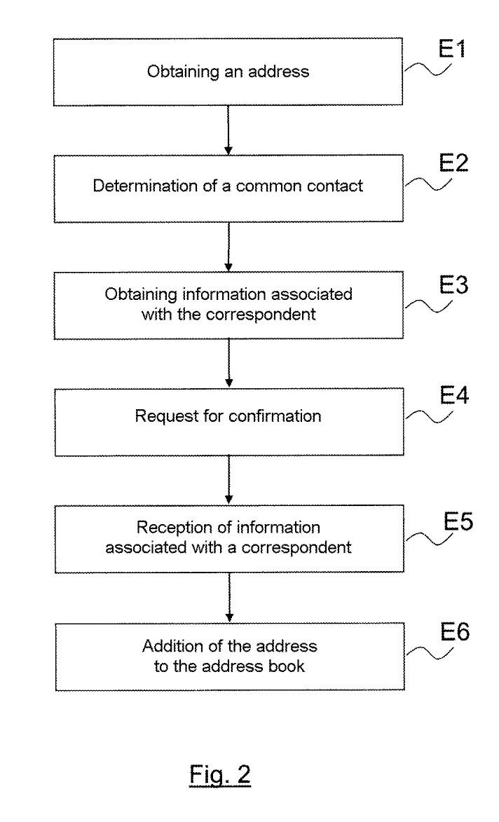

FIG. 2 shows steps of the method for automatic addition according to the invention,

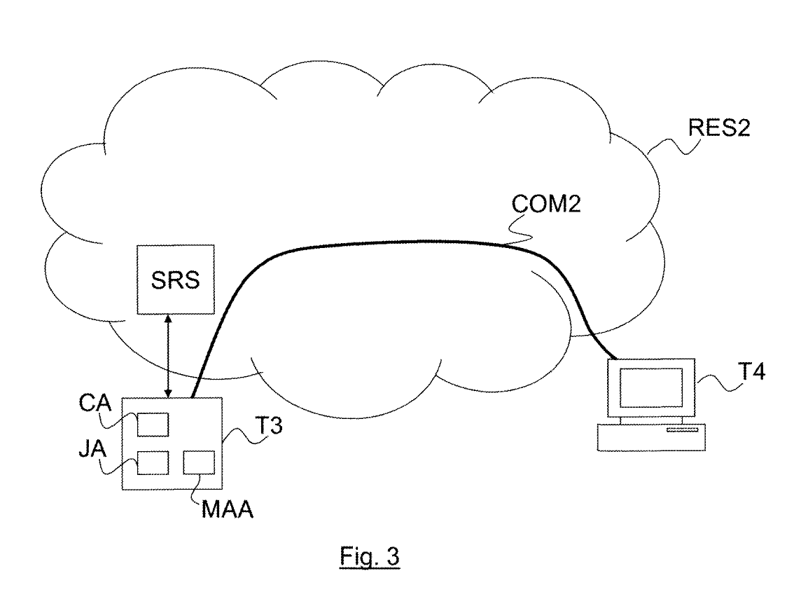

and FIG. 3 shows a second embodiment of the system for automatic addition according to the invention.

According to a first embodiment of the invention shown in FIG. 1, the method for automatic addition according to the invention is implemented in a communications network RES1 by the operator of a user subscriber, this user using a mobile terminal T1 for accessing the communications network RES1.

The user has an online address book, hosted in a database BCA of online address books, within the communications network RES1. The terminal T1 also comprises a local address book allowing the user to find the coordinates of his contacts even when the terminal T1 is not connected to the communications network RES1. This local address book is synchronized with the online address book of the user, for example by means of periodic updates between these two address books. In this embodiment of the invention, it is also assumed that the database BCA of address books also hosts the address books of the contacts of the user, and the address book of a correspondent of the user, who has just established, on his terminal 12, a communications session COM1 with the terminal T1 of the user. The terminal T2 is for example a wireless telephone connected to a DECT (from the English term “Digital Enhanced Cordless Telecommunications”) base, connected by a USB (from the English term “Universal Serial Bus”) port to a domestic gateway PAD.

It should be noted that, in this exemplary embodiment, for simplicity, all the address books used are hosted in the database BCA of address books. As a variant, the address books of the contacts of the user, and/or the address book of the correspondent, are hosted in a network other than the communications network RES1. In this case, the communications operator of the user, for example, establishes agreements with the communications operator of this other network in order to obtain information on the address books of the subscribers of this other communications operator. This information is for example obtained via an interface to a server managing the connectivity between address books of subscribers of this other operator, this interface responding to simple interrogations such as “Is such and such an address present in the address book of such and such a subscriber?”.

In addition, other variant embodiments may be envisioned. For example, as a variant, the terminal T1 or the terminal T2 are fixed terminals or use other technologies, such as WiFi (Wireless Fidelity, according to the standard Institute of Electrical and Electronics Engineers (IEEE) 802.11). Lastly, it should be noted that the communications session COM1 here is a voice over IP (from the English term “Internet Protocol”) session, using IMS architecture, but that the invention also takes into account other types of communications sessions between the user and the correspondent, such as SMS text messages, videoconference sessions, voice calls over the STN network (Switched Telephone Network) or else instant messaging sessions. The type of communications session potentially influences a criterion for automatic addition of an address of the correspondent to the address book of the user, depending on the configuration of predefined rules governing this addition criterion.

These rules are stored in a server SAA in the communications network RES1. Using these rules, this server determines whether the criterion for automatic addition of a address of the correspondent to the address book of the user is verified and, in the affirmative, manages this addition. For this purpose, it has an interface with the database ECA of address books.

In addition, the server SAA has an interface with a call log server SJA. This server SJA keeps records of all the calls of the subscribers of the communications operator of the user. For the user of the terminal T1, the server SJA therefore keeps data on all the communications sessions involving the terminal T1. For such a communications session, these data notably comprise the nature of the communications session, the address of the correspondent of the user in this communications session, the duration of the session, and whether the user or the correspondent is the originator of this session.

The method for automatic addition according to the invention is now described in relation to FIG. 2, which shows this method in the form of an algorithm comprising steps E1 to E6.

The method according to the invention is implemented in the server SAA. As a variant, the method according to the invention is implemented within several physical entities of the communications network RES1.

It is assumed that, prior to the implementation of the method according to the invention in the server SAA, the user has just finished the communications session COM1 with the correspondent. The end of this session is notified to the call log server SJA by an S-CSCF (from the English term “Serving Call State Control Function”) server in the communications network RES1. This notification allows the call log server SJA to update the history of the communications of the user with data associated with the communications session COM1. As a variant, the call log server SJA uses a periodic interrogation of the information system of the communications operator, in order to update the history of the communications of the user.

Once the history of the communications of the user has been updated by the call log server SJA, the latter notifies the server SAA of this update.

The step E1 is the obtaining of an address of the correspondent by the server SAA. Since the communications session COM1 is a voice over IP session, this address is an SIP address. This address is supplied to the server SAA by the call log server SJA in the update notification that it previously sent it, when this address is available in the signaling of the communications session. This notification also comprises the nature of the communications session COM1, in other words here a voice over IP session, the duration of the communications session COM1, and whether the call is incoming or outgoing from the point of view of the user. More precisely, there are two separate cases:
If the communications session COM1 that has just ended is an outgoing call, the user has manually input the SIP address of the correspondent into his terminal T1. This address is then transmitted in the signaling necessary for the establishment of the communications session COM1, held in the S-CSCF within a call context, then saved at the end of the call in the call log server SJA, which then transmits it to the server SAA within its update notification.
If the communications session COM1 which has just ended is an incoming call, the S-CSCF only saves in the call log server SJA the SIP address of the correspondent, present in the signaling necessary for the establishment of the communications session COM1, if this address is not “masked”, in other words if the correspondent has not subscribed to the service for non-display of his SIP address. In the contrary case, where the correspondent has subscribed to the service for non-display of his SIP address, this step E1 and the following ones are not carried out, since the invention is not used.

However, in this embodiment of the invention, this limitation associated with masked addresses is due to the compliance of the service to which the correspondent subscribes for non-display of his SIP address. This limitation may actually technically be bypassed. For example, in the case where the SIP address of the correspondent is masked, it suffices to request the latter to send his SIP address by SMS at the end of the communications session COM1.

The following step E2 is the determination of a common contact between the user and the correspondent. For this purpose, the server SAA interrogates the database BCA of address books. For each contact present in the address book of the user, it determines whether the address of the correspondent obtained at the step E1 is present in the address book of this contact, or if an address of this contact is present in the address book of the correspondent. If one of these two conditions is verified for at least one contact present in the address book of the user, then this contact is a common contact between the user and the correspondent, that the server SAA has determined. It is assumed, in this embodiment of the invention, that the server SAA has determined a common contact between the user and the correspondent.

In the following step E3, information associated with the correspondent is obtained. There are two separate cases:
If the address of the correspondent obtained at the step E1 is present in the address book of the common contact, then the server SAA interrogates the entries linked to the correspondent in the address book of the common contact in order to determine information associated with the correspondent. For example, this information is the name of the correspondent and his address.
If an address of this common contact is present in the address book of the correspondent, but the address of the correspondent obtained at the step E1 is not present in the address book of the common contact, then the server SAA interrogates other databases allowing a name to be associated, for example, with the address of the correspondent obtained at the step E1, such as a reverse directory, or a database of the information system of the communications operator common to the user and the correspondent.

At the end of this step E3, with the information at its disposal on the communications session COM1 and on the correspondent, the server SAA determines whether the addition criterion of the address of the correspondent, determined at the step E1, in the address book of the user, is verified. For this purpose, it uses the rules governing this addition criterion stored in the server SAA. These rules use a communication history of the user, accessible through the call log server SJA. These rules state for example that:
the address of the correspondent is added automatically to the address book of the user after five incoming calls, if there exists a common contact between the correspondent and the user, and after reception of a positive response to a request for confirmation of addition from the user.
or the address of the correspondent is added automatically in the address book of the user following an outgoing call, if there exists a common contact between the correspondent and the user.
or the address of the correspondent is added automatically to the address book of the user after five instant messaging sessions shared with this correspondent, if there exists a common contact between the correspondent and the user, and after reception of a positive response to a request for confirmation of addition from the user.
   Of course, many other configurations of the rules governing this addition criterion may be envisioned. For example, as a variant, these rules depend on the existence of a common contact between the correspondent and the user, but also on the frequency and on the duration of the previous calls between the user and the correspondent, or alternatively on the localization of the correspondent or of the user at the time of the last call. It is furthermore assumed, in this embodiment of the invention, that the communications session COM1 corresponds to the fifth incoming call from the correspondent to the user.

The following step E4 is the emission of a request for confirmation of the addition of the address of the correspondent to the address book of the user, by the server SAA, in the terminal T1. This is for example sent by SMS, or by USSD (from the English term “Unstructured Supplementary Service Data”). Indeed, since the communications session COM1 is, in this embodiment, the fifth incoming call from the correspondent to the user, the rules governing this addition criterion demand a confirmation from the user prior to this automatic addition.

It is assumed, in this embodiment of the invention, that the user responds positively to this request for confirmation. Then, in order to complete a new entry corresponding to the correspondent in his address book, the server SAA suggests that the user input one or more pieces of information associated with the correspondent, for example the name or the address of latter. This suggestion is for example made in a new SMS or USSD message, or in the same message as that containing the request for confirmation. If at the step E3 the server SAA has obtained such information, it is presented to the user in this suggestion.

The following step E5 is the reception of information associated with the correspondent. It is indeed assumed, in this embodiment of the invention, that the user responds to the suggestion sent at the step E4 by the server SAA, by inputting a name or an address to be associated with the address of the correspondent in the address book of the user to the server SAA. In the case where the server SAA has already obtained this information at the step E3, this input is simply a validation or a correction of the information presented by the server SAA at the step E4 in order to complete the address book of the user.

Finally, the step E6 is the addition of the address of the correspondent to the address book of the user, completed by the information obtained at the step E3 and/or at the step E5. For this purpose, the server SAA carries out a request for writing in the database BCA of address books.

It should be noted that numerous variants of this first embodiment of the invention may be envisioned, the order of the steps not being fixed for the purposes of the invention, certain steps being optional, and various embodiments of these steps being possible. For example, as a variant embodiment of the invention, only the steps E1, E2 and E6 are implemented. Similarly, in another variant, the step E3 is implemented after the step E5. Finally, in yet another variant, in the step E3 the server SAA obtains information associated with the correspondent in a different manner with respect to the main variant embodiment of the invention: it sends a message to the correspondent in order to ask him to identify himself and, where appropriate, to provide other personal information allowing the user to easily locate him in his address book, such as a nickname.

According to a second embodiment of the invention shown in FIG. 3, the method for automatic addition according to the invention is implemented in a mobile terminal T3 of a user, connected to a communications network RES2. The terminal T3 of the user comprises an address book CA, a call log JA and a software module MAA for automatic addition implementing the method for automatic addition according to the invention.

It is assumed, in this second embodiment of the invention, that the user of the terminal T3 has just ended a communications session COM2, for example an instant messaging session, with a correspondent on a terminal T4. The terminals T3 and T4 are, in this embodiment, desktop computers. Other types of terminals may of course be used, as in the first embodiment of the invention.

The method for automatic addition according to the invention is now described in this second embodiment of the invention, with reference to FIG. 2, which shows this method in the form of an algorithm comprising steps E1 to E6.

The step E1 is the obtaining of the email address of the correspondent by the module MAA for automatic addition. For this purpose, the module MAA for automatic addition consults the call log JR of the terminal T3, which keeps a history of the instant messaging sessions of the user, and notably the email addresses of the participants in these sessions, which are transmitted within the signaling messages used to establish these sessions.

The step E2 is the determination of a common contact between the user and the correspondent. For this purpose, the module MAA for automatic addition accesses a database of a social network server SRS in the communications network RES2, the user being a member of the social network hosted by the server SRS. The membership of the user in this social network is for example indicated in a centralized user profile in the communications network RES2, or local to the terminal T3. As a variant, a URL (from the English term “Uniform Resource Locator”) of the social network server SRS is directly configured in the data of the module MAA for automatic addition. The module MAA for automatic addition also obtains, if necessary, means for connecting to the social network server SRS, such as a login username and a password, accessible for example in the user profile or in the configuration data of the module MAA for automatic addition.

In this step E2, the module MAA for automatic addition uses the email address of the correspondent in order to determine, using the database of the social network server SRS, if the correspondent also belongs to this social network. In the affirmative, the module MAA for automatic addition determines, also using this database, whether the user and the correspondent have a relationship in this social network and what is the degree of this relationship. This determination is specific to each type of social network. For example, if the social network server SRS hosts the site Pikeo®, the module MAA for automatic addition determines whether the correspondent is in the list of contacts of the user, or whether the user is in the list of contacts of the correspondent. If one of these conditions is verified, then the module MAA for automatic addition has determined that the user and the correspondent are in direct contact on this social network. Similarly, for each contact in the list of contacts of the user, the module MAA for automatic addition determines whether this contact is in the list of contacts of the correspondent. In the affirmative, this contact is a common contact between the user and the correspondent, determined by the module MAA for automatic addition.

As a variant, the module MAA for automatic addition accesses as many servers of social networks in the communications network RES2 as those indicated in the user profile, in order to determine a common contact with the correspondent in each of the these social networks. If the module MAA for automatic addition also has access to a centralized profile of the correspondent comprising an indication of the social networks to which the correspondent is affiliated, this determination is preferably limited to the social networks common to the correspondent and the user. In this variant, the determination of a common contact between the user and the correspondent is adapted to each social network which the module MAA for automatic addition accesses. For example, the identifier of the user or of the correspondent used in order to interrogate the database of a social network server is not necessarily the email address of the user or of the correspondent. It is, for example, an identifier common to several online services, of the type “OpenID®”, that the module MAA for automatic addition obtains for example in the profile of the user or a centralized profile of the correspondent, or in applications data of the instant messaging session COM2.

In the following step E3, information associated with the correspondent is obtained. For this purpose, the module MAA for automatic addition consults the data of the correspondent in the social network server SRS. This information is for example a name or a nickname, a geographical address, a telephone number or else fields of interest.

At the end of this step E3, the module MAA for automatic addition determines, with the information at its disposal on the communications session COM2 and on the correspondent, whether a criterion for addition of the email address of the correspondent, determined at the step E1, to the address book CA of the user, is verified. For this purpose, it uses rules governing this addition criterion, configured in the module MAA for automatic addition. These rules indicate for example that the email address of the correspondent is automatically added to the address book CA of the user at the end of an instant messaging session:
if the latter lasts more than thirty minutes between the correspondent and the user,
if there exists a common contact between the correspondent and the user in the social network hosted by the server SRS, or if the correspondent and the user are in direct contact in this social network,
and after reception of a positive response to the request for confirmation of addition from the user.

As a variant, if at the step E2 the module MAA for automatic addition has determined a common contact between the user and the correspondent in several social networks, these rules indicate for example that, at the end of an instant messaging session, the email address of the correspondent is automatically added to the address book of the user if:
there exists the same common contact or a direct contact between the correspondent and the user in at least a predetermined number of social networks,
or there exists at least a predetermined number of common contacts between the correspondent and the user in at least one social network.

In another variant, a level of connectivity between the user and the correspondent is taken into account in these rules, this level of connectivity being for example defined as the minimum number of intermediate contacts allowing the user to be connected to the correspondent. It goes without saying that it is possible, in many other variants, to make the rules governing this addition criterion depend on many other factors, such as the existence of common fields of interest between the user and the correspondent.

It is furthermore assumed, in this step E3, that the criterion for automatic addition of the email address of the correspondent to the address book of the user is verified.

The following step E4 is the emission of a request for confirmation of the addition of the email address of the correspondent to the address book of the user by the module MAA for automatic addition. This request is made for example in the form of an applications message to a display interface of the terminal T3 to display a pop-up window on a screen of the terminal T3, asking the user if he would like to add the email address of the correspondent to his address book CA.

In this step E4, it is assumed that the user responds positively to this request for confirmation. The module MAA for automatic addition then suggests that, in order to complete a new entry corresponding to the correspondent in his address book CA, the user input one or more pieces of information associated with the correspondent, for example the name or the geographical address of the latter. This suggestion is made for example in a new pop-up window comprising one or more field(s) for inserting text. If at the step E3 the server SAA has already obtained some of this information on the correspondent, the corresponding text insertion fields are pre-filled and modifiable.

The following step E5 is the reception of information associated with the correspondent. It is indeed assumed, in this embodiment of the invention, that the user has input into the text insertion fields displayed on his terminal T3, at the step E4, a name or a geographical address to be associated with the email address of the correspondent in his address book CA, or else has corrected or validated such fields when they have been pre-filled.

Finally, the step E6 is the addition of the email address of the correspondent to the address book CA, by the module MAA for automatic addition. The entry of this address into the address book CA is furthermore completed by the information obtained at the step E3 and/or at the step E5.

It should be noted that, as in the first embodiment of the invention, numerous variants of this second embodiment of the invention may be envisioned, the order of the steps not being fixed for the purposes of the invention, certain steps being optional, and various embodiments of these steps being possible. For example, as a variant of the step E1, the module MAA for automatic addition obtains the email address of the correspondent in an online instant messaging profile associated with the correspondent, to which profile he has access thanks to an identifier inserted in one of the messages of the communications session COM2.

1. A method for automatically adding an address of a correspondent to an address book of a user, comprising:
establishing a communications session between said user and said correspondent;
obtaining said address; and
adding said address to said address book, wherein
said addition step is preceded by a step for determining a common contact between said user and said correspondent, and
in that said addition step is conditioned by the result of said determination step and the respect of at least one rule taking into account a communication history of said user.

2. The method according to claim 1, wherein said determination step uses a database of a social network to which said user belongs.

3. The method according to claim 1, in which:
an address book of the common contact or an address book of the correspondent are accessible from a communications network, and
an address of said common contact is present in the address book of the user,
wherein
said determination step uses data contained in at least one of said address books of the common contact or of the correspondent, a common contact between the user and the correspondent being determined if an address of the correspondent is present in said address book of the common contact, or if said address of the common contact is present in both said address book of the user and said address book of the correspondent.

4. The method according to claim 2, wherein said determination step is followed by a step for obtaining information linked to said correspondent and contained in said social network or in said address book of said common contact.

5. The method according to claim 1, wherein said addition step is preceded by a step for requesting confirmation from the user of the addition of said address to said address book of the user.

6. The method according to claim 5, wherein said confirmation request step is followed by a step for receiving information associated with said address, provided by the user.

7. A system for automatically adding an address of a correspondent to an address book of a user, a communications session having been established between said user and said correspondent, comprising:
means for obtaining said address,
means for adding said address to said address book depending on a set of rules taking account of a communication history of said user; and
means for determining a common contact between said user and said correspondent, said determination means being used by at least one of said rules.

8. A non-transitory computer program product comprising instructions for implementing the method according to claim 1, when it is executed on at least one processor.
